(19) United States
(12) Patent Application Publication
(10) Pub. No.: US 2018/0317174 A1
(43) Pub. Date: Nov. 1, 2018

(54) POWER SAVINGS IN A POWER-SENSITIVE DEVICE TETHERED OVER A WIRELESS LINK

(71) Applicant: QUALCOMM Incorporated, San Diego, CA (US)

(72) Inventors: Nishith CHAUBEY, San Diego, CA (US); Hiren BHAGATWALA, San Diego, CA (US); Anil RAO, San Diego, CA (US); Nikhil JAIN, San Diego, CA (US)

(21) Appl. No.: 15/582,621

(22) Filed: Apr. 29, 2017

(51) Int. Cl. H04W 52/02; H04W 76/02; H04W 68/00

(52) U.S. Cl. CPC H04W 52/0248; H04W 68/005; H04W 76/028

(57) ABSTRACT

The disclosure generally relates to power savings in a power-sensitive device tethered to another device over a wireless link. For example, a first wireless device may establish a wireless link with a second device such that the first wireless device is tethered to the second device over the wireless link. The first wireless device may determine that a scheduled untethering of the wireless link with the second device is impending and reduce a duty cycle associated with one or more procedures to reestablish the wireless link in response to determining that the wireless link with the second device has been lost. The duty cycle may be reduced for a period that substantially corresponds to an expected duration of the scheduled untethering of the wireless link.

### TECHNICAL FIELD

The various aspects and embodiments described herein generally relate to wireless communications, and more particularly, to power savings in a mobile device.

### BACKGROUND

Devices using wireless technologies may be configured to maintain a wireless communication connection through establishing/reestablishing an on-demand and/or an always-on connection. However, various problems can be encountered when attempting to maintain or establish such a wireless communication connection. For example, a user may move one device or the other such that the devices are no longer within sufficient communication range from one another. Furthermore, signal interference or other factors may cause a connection to temporarily drop. Accordingly, there may be a frequent need to reestablish the wireless communication link between the devices in various scenarios. However, conserving battery power is also an important design consideration in many mobile computing devices.

For example, wearables tend to be very power-sensitive devices. In many cases, a wearable device is paired and tethered to another user equipment (UE) (e.g., a smartphone) over a wireless link. At certain times, the wearable device may operate in a “sniff” mode or another suitable low-power mode just to make sure that the link is healthy. At other times, when the wireless link is broken (e.g., because the wearable and the tethered device are no longer within range of each other), both devices enter a higher power mode in an effort to determine whether communications can be re-established (e.g., a slave may enter a page scan mode and a master may enter a page mode). This transition has high power implications, but is also a necessary evil to some extent to allow the devices to re-establish the connection as soon as possible. However, in circumstances where the devices are out-of-range and expected to stay out-of-range, re-establishing the connection may be not be possible, making the transition to the higher power mode unnecessarily wasteful.

In general, the above-mentioned out-of-range scenarios generally fall into one of two categories, which include (i) an “unexpected untethering” that can last anywhere from a few seconds to few minutes (e.g., a user leaving his/her phone on desk to go to the restroom), and (ii) an “expected untethering” that could last from several minutes to several hours or longer (e.g., the user going out for a jog and only carrying the watch while leaving the phone at home—a very common scenario for wearables). In the latter case, no matter how long the watch performs the page scanning procedure, the page scanning will be useless until the user returns back to home, which has a substantial power impact without having any useful work done the entire duration. Accordingly, mechanisms to avoid unnecessary power consumption when a wireless connection is known or expected to be lost (at least temporarily) are desired.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method for power savings in a wireless device may comprise establishing, at a first wireless device, a wireless link with a second device such that the first wireless device is tethered to the second device over the wireless link, determining, at the first wireless device, that a scheduled untethering of the wireless link with the second device is impending, and reducing a duty cycle associated with one or more procedures to reestablish the wireless link in response to determining that the wireless link with the second device has been lost, wherein the duty cycle is reduced for a period that substantially corresponds to an expected duration of the scheduled untethering of the wireless link. For example, reducing the duty cycle associated with the one or more procedures to reestablish the wireless link may comprise suspending page messages to be transmitted to the second device and/or operations to scan for page messages transmitted from the second device. In another example, reducing the duty cycle associated with the procedures to reestablish the wireless link may comprise increasing a paging interval and/or a page scanning interval. The normal duty cycle for the one or more procedures to reestablish the wireless link may resume after the expected duration of the scheduled untethering has elapsed.

According to various aspects, the scheduled untethering may be an event for which a user has indicated that the first wireless device and the second device will not be within communication reception range. For example, the scheduled untethering may be an event stored in a calendar associated with the user and tagged with information to indicate that the first wireless device and the second device will not be within communication reception range. In other examples, the method may comprise tracking information associated with one or more scheduled untethering events over time (e.g., days, times, and durations in which the first wireless device becomes untethered from the second device) and identifying one or more patterns among the tracked information associated with the one or more scheduled untethering events, wherein the scheduled untethering may be determined based on the one or more identified patterns.

According to various aspects, that the scheduled untethering is impending may be determined based on a user input received at the first wireless device indicating that the scheduled untethering is impending. In other examples, the scheduled/impending untethering may be determined based on the first wireless device receiving, via the wireless link, a message from the second device indicating that the scheduled untethering is impending, wherein the message may further indicate a start time and the expected duration of the scheduled untethering. Alternatively, the first wireless device may transmit a message to the second device to indicate that the scheduled untethering is impending, wherein the message transmitted to the second device may further indicate a start time and the expected duration of the scheduled untethering.

According to various aspects, an apparatus may comprise a memory and a processor coupled to the memory, wherein the processor may be configured to establish a wireless link with a tethered device, determine that a scheduled untethering of the wireless link with the tethered device is impending, and reduce a duty cycle associated with one or more procedures to reestablish the wireless link in response to loss of the wireless link with the tethered device, wherein the duty cycle is reduced for a period that substantially corresponds to an expected duration of the scheduled untethering of the wireless link.

According to various aspects, an apparatus may comprise means for establishing a wireless link with a tethered device, means for determining that a scheduled untethering of the wireless link with the tethered device is impending, and means for reducing a duty cycle associated with one or more procedures to reestablish the wireless link in response to loss of the wireless link with the tethered device, wherein the duty cycle is reduced for a period that substantially corresponds to an expected duration of the scheduled untethering of the wireless link.

According to various aspects, a computer-readable storage medium may store computer-executable instructions configured to cause a processor to establish a wireless link with a tethered device, determine that a scheduled untethering of the wireless link with the tethered device is impending, and reduce a duty cycle associated with one or more procedures to reestablish the wireless link in response to loss of the wireless link with the tethered device, wherein the duty cycle is reduced for a period that substantially corresponds to an expected duration of the scheduled untethering of the wireless link.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary system in which two wireless devices may communicate over a wireless link, according to various aspects.

FIG. 2 illustrates an exemplary wearable device that may be suitably used in accordance with the various aspects and embodiments described herein.

FIG. 3 illustrates an exemplary system in which two wireless devices can communicate over a wireless link, according to various aspects.

FIG. 4 illustrates an exemplary call flow to establish or reestablish a wireless link between two wireless devices, according to various aspects.

FIG. 5 illustrates an exemplary call flow to suspend or reduce attempts to reestablish a wireless link during an expected untethering, according to various aspects.

FIG. 6 illustrates an exemplary method to suspend or reduce attempts to reestablish a wireless link during an expected untethering, according to various aspects.

FIG. 7 illustrates an exemplary mobile device that may be suitably used in accordance with the various aspects and embodiments described herein.

FIG. 8 illustrates an exemplary wearable device that may be suitably used in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can communicate with a radio access network (RAN) that implements a particular radio access technology (RAT), over a wired network, over a Wi-Fi network (e.g., based on IEEE 802.11, etc.), and/or with other devices via a direct device-to-device (D2D) or peer-to-peer (P2P) connection.

As used herein, the term “wearable device” and variants thereof may refer to a mobile device designed to be carried or otherwise worn by a user. For example, in various embodiments, wearable devices may be shown in the drawings and described in the following description as wearable devices that are attached to a user's arm, specifically at the wrist like a watch. However, those skilled in the art will appreciate that such example wearable devices are intended to be exemplary and illustrative only and not intended to be limiting in any way. Other example wearable devices may be removably attached to or integrated into the user's clothing or accessories, worn around the user's neck (e.g., as on a cord or chain), or worn attached to the user's head, such as an earpiece, glasses-like frames, a headband, or a hat.

As used herein, the term “tethered” (or “tethering”) and variants thereof may refer to a state or event in which two wireless devices are connected to one another over a suitable device-to-device (D2D) or peer-to-peer (P2P) wireless link. For example, various aspects and embodiments are described herein in relation to devices configured to communicate with one another over a short-range wireless link in accordance with Bluetooth® wireless technology. However, those skilled in the art will appreciate that such description is illustrative only, and that the various aspects and embodiments described herein contemplate devices that may be tethered to one another over any suitable existing or future-developed technology (e.g., including Wi-Fi Direct, LTE-Direct, etc., which may enable direct device-to-device communications over a larger range than Bluetooth and other short-range communication protocols).

Devices using wireless technologies may be configured to establish and/or maintain a wireless communication connection either through establishing the connection on-demand or establishing an always-on connection. For example, according to various embodiments, devices that may establish and/or maintain a wireless communication connection may include a smartwatch and a smartphone, a smartphone and a vehicle infotainment system, etc. In various circumstances, problems can be encountered with maintaining or establishing such a wireless communication connection. For example, the user may move one device or the other such that the devices are no longer within communication range. Also, signal interference or other factors may cause the connection to drop. As such, there may be a frequent need to reestablish the wireless communication link between the devices. However, conserving battery power is also an important design consideration in such mobile computing devices. Therefore, methods that enable establishing and/or maintaining the wireless communication link between such devices without draining a battery on either the mobile device or the wearable device are desirable.

More particularly, as will be described in further detail herein, various aspects and embodiments generally relate to techniques to avoid or at least reduce unnecessary attempts to reestablish a wireless connection (e.g., during periods when the devices are known or otherwise expected to not be in communication range). For example, in at least some instances, two wireless devices may be paired with one another and tethered to one another over an appropriate D2D (or P2P) wireless link. In general, while actively connected or otherwise tethered, the wireless device(s) may operate in a low-power mode (e.g., a sniff mode) to occasionally check that the wireless link is still active and healthy. However, when the wireless link between the wireless devices is broken or otherwise lost, the wireless devices may enter a higher power mode in an effort to reestablish communications with each other (e.g., a master device may enter a page mode and a slave device may enter a page scan mode). Although entering the higher power mode has substantial power implications, especially on wearables or other power-sensitive devices, entering the higher power mode at some point is needed to allow the devices to reestablish an active connection as soon as possible. However, in the event that the out-of-range issues can be suitably predicted, predetermined, learned, etc., the wireless devices may forego the high power operations otherwise used to reestablish communications or at least be less aggressive trying to find each other. Accordingly, as will be described in further detail herein, the wireless devices may generally reduce a duty cycle associated with one or more procedures otherwise used to reestablish the connection when the connection is lost and the connection loss was scheduled or otherwise expected. For example, in various embodiments, the duty cycle may be reduced for a period that substantially corresponds to an expected duration of the scheduled/expected untethering (although a user may be provided with the option to manually trigger a return to the normal duty cycle).

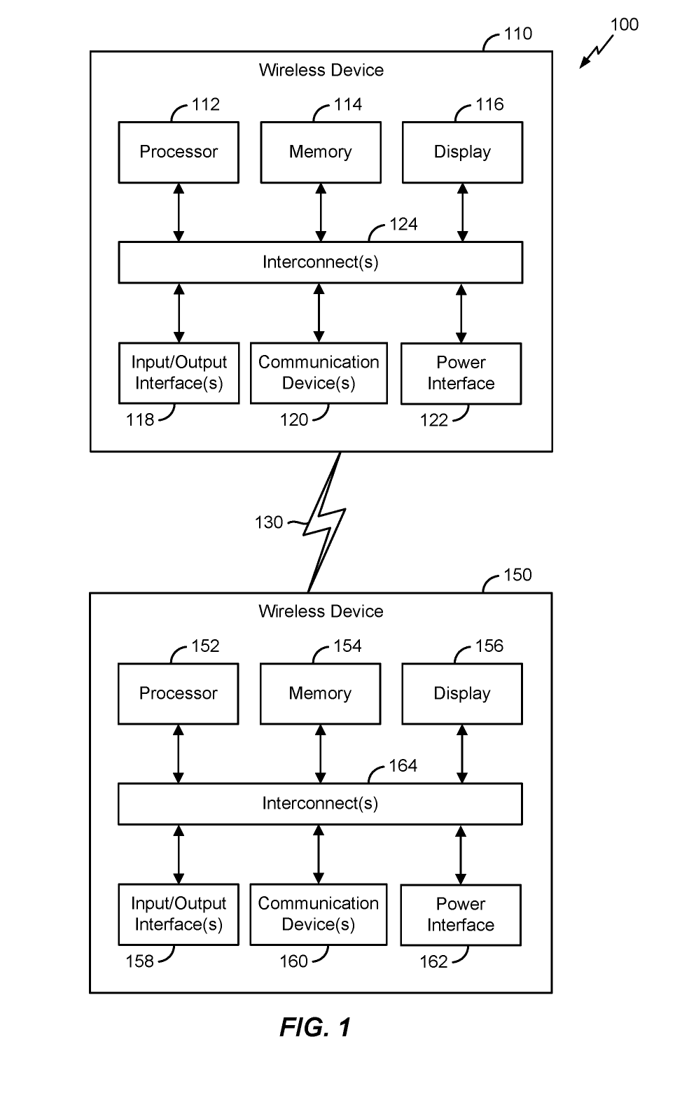

For example, according to various aspects, FIG. 1 illustrates an exemplary system 100 in which a first wireless device 110 and a second wireless device 150 may communicate over a wireless link 130. The wireless devices 110, 150 may include respective processors 112, 152, memories or storage units 114, 154, displays 116, 156, input/output interfaces 118, 158, communication devices 120, 160, power interfaces 122, 162, which can be coupled together via respective interconnects 124, 164. In general, the interconnects 124, 164 may include a data bus and a power bus, a control signal bus, and/or a status signal bus in addition to the data bus. In various embodiments, the wireless devices 110, 150 can also include other components or elements not illustrated in FIG. 1. One or more components associated with the wireless devices 110, 150 can be in communication with one another via means that may comprise the wireless link 130 or another suitable communication channel.

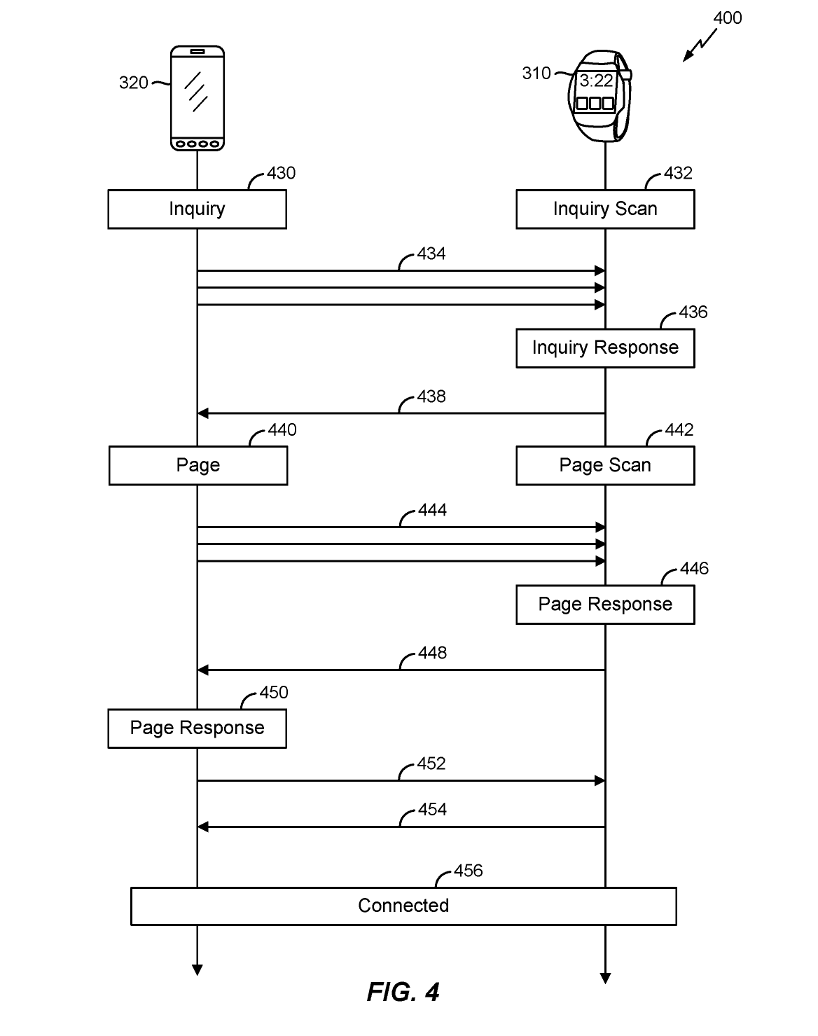

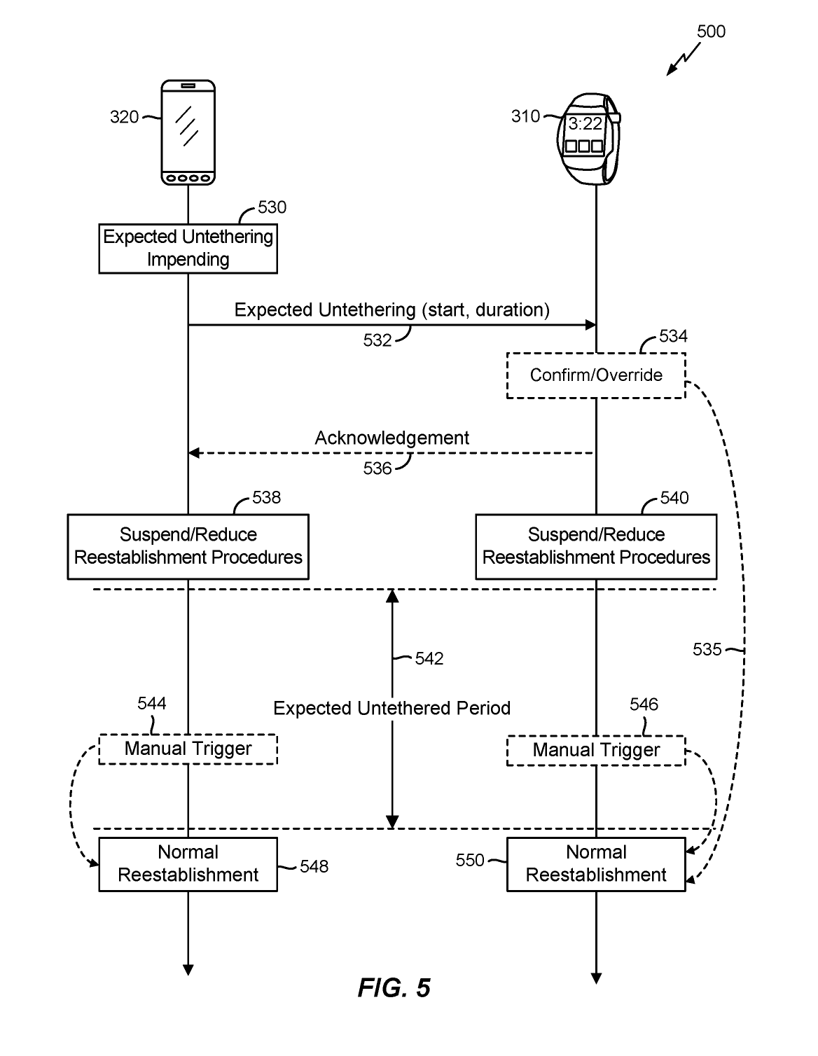

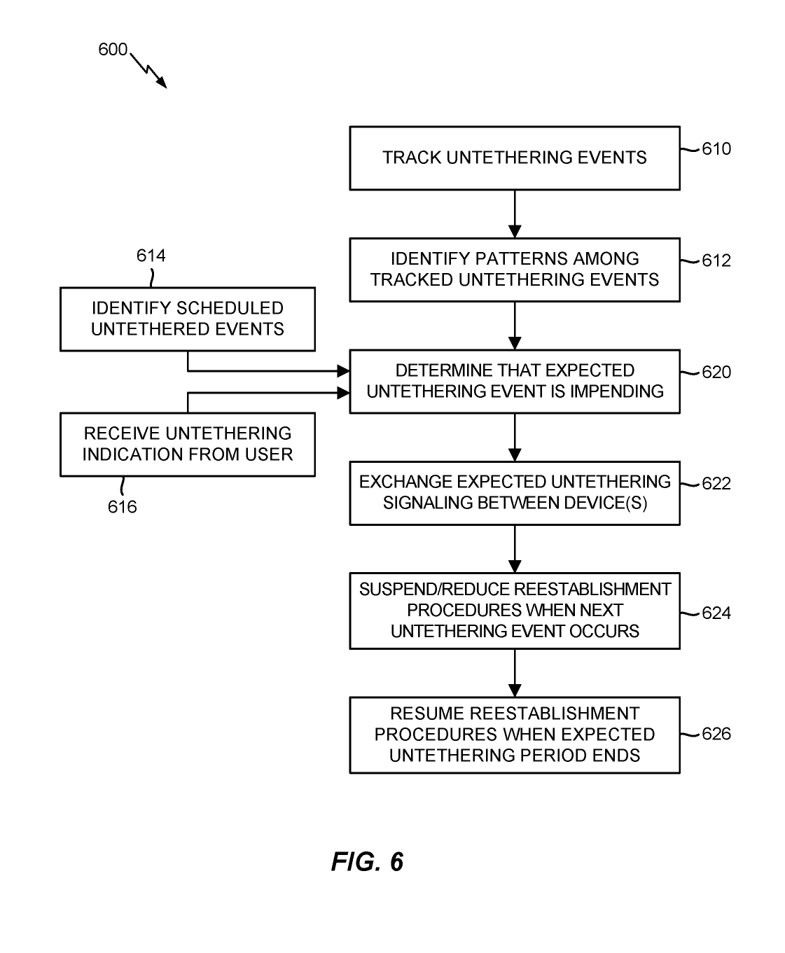

In various embodiments, the processor 112, 152 may be any type of general purpose processors, such as a central processing unit (CPU) or microprocessor, specialized processor, such as a graphics processing unit (GPU), physics processing unit (GPU), accelerated processing unit (APU), digital signal processor (DSP) or microcontroller, or any other programmable logic circuit. The processor 112, 152 may also be configured as an integrated circuit (IC) or system-on-chip (SoC). The processor may be configured to execute processor instructions stored on the memory 114, 154, such as processor instructions embodying the functionality in FIG. 4, FIG. 5, and FIG. 6, which is described in further detail below.

In various embodiments, the memory or storage unit 114, 154 may be or include any of a wide array of volatile and non-volatile types of memory. In various embodiments, the memories 114, 154 may include one or more of various types of a random access memory (RAM), a read only memory (ROM), a flash memory, and a hard disk drive (HDD). Other types of memory may include magnetic, optical, or hybrid memory devices. The memory may be configured to store processor instructions embodying the functionality in FIG. 4-6, which is described in further detail below.

In various embodiments, the displays 116, 156 may be a video, an audio, or a haptic component for presenting a visual, an audible, or a tactile output. Some example displays 116, 156 may include a liquid crystal display (LCD) screen, an organic light emitting diode (OLED) screen, and an active matrix OLED (AMOLED) screen. Such displays 116, 156 may include resistive, capacitive, infrared, and/or optical imaging touch screen capabilities. Other examples may include a speaker, a vibration motor, and a haptic enabled screen.

In various embodiments, the input/output interfaces 118, 158 may be configured to receive signals provided by the user or the surrounding of the wireless devices 110, 150. Example input/output interfaces 118, 158 may include, a button, a key, a switch, a touch sensitive surface, a microphone, and a sensor, which may sense one or more of various inputs, such as light, sound, temperature, position, movement, atmospheric pressure, and electromagnetic radiation.

In various embodiments, the communication devices 120, 160 may include one or more components configured to enable the wireless devices 110, 150 to communicate over the wireless link 130. Such items may include a radio frequency (RF) transceiver, an antenna, and a modem. The communication devices 120, 160 may be used with the other components of the wireless devices 110, 150 to implement various wired and/or wireless transmission protocol stacks and interfaces. For example, in various embodiments, the communication devices 120, 160 may be tethered to each other over the wireless link 130 using Bluetooth or another suitable communication protocol. However, those skilled in the art will appreciate that another suitable radio access technology (RAT) may be used to communicate over the wireless link 130. For example, the communication devices 120, 160 may communicate with one another such that the wireless devices 110, 150 are tethered over the wireless link 130 via Wi-Fi Direct, LTE-Direct, or another suitable technology. The wireless link 130 may therefore allow for wired and/or wireless connection and communication between the wireless devices 110, 150. The wireless link 130 may be implemented via a wired or wireless a personal area network (PAN) or local area network (LAN) and implemented using any of various suitable communication protocols, for example, Bluetooth, Wi-Fi (or Wi-Fi Direct), LTE-Direct, Peanut, ZigBee, and wired serial communications.

Furthermore, according to various embodiments, the communication devices 120, 160 may operate via other wireless links (not shown) according to one or more other RATs depending on the network in which the wireless devices 110, 150 are deployed. For example, the network(s) may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi.”

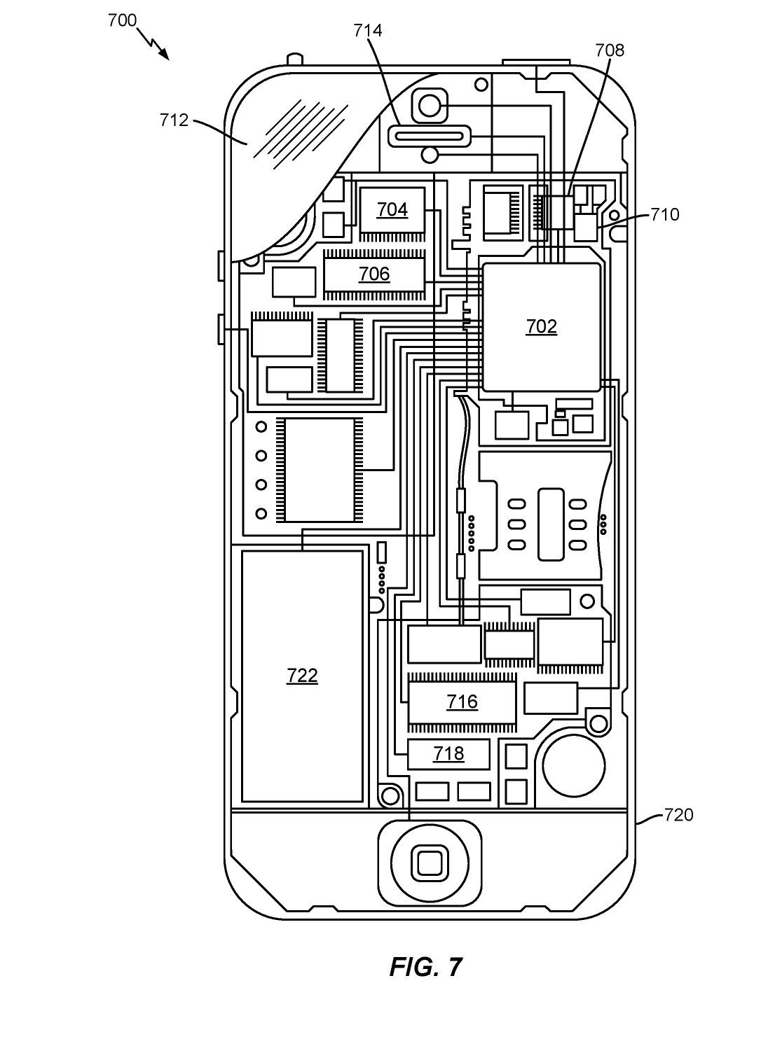

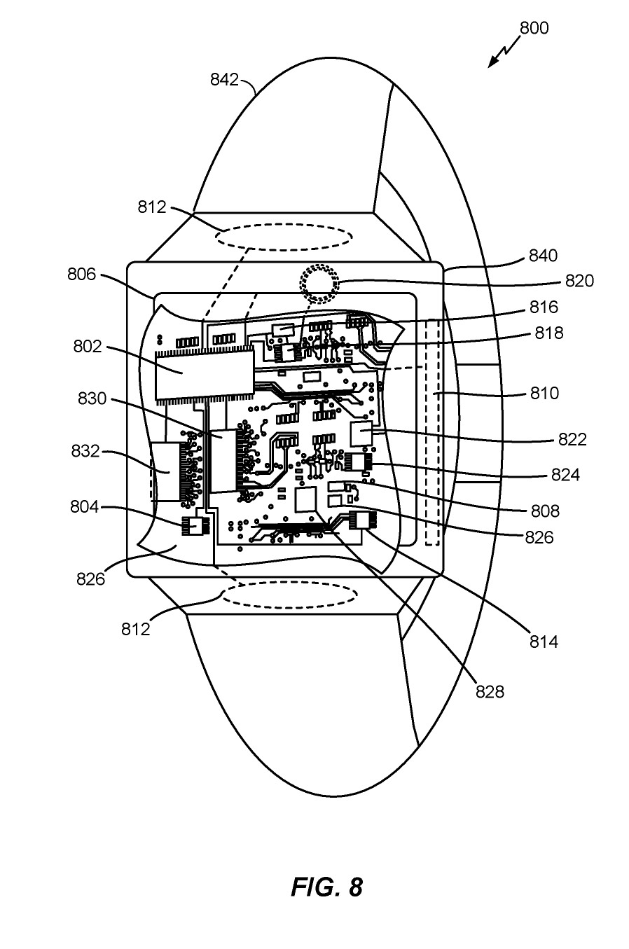

In various embodiments, the power interface 122, 162 may include components to connect to a power source (not shown) external to the wireless devices 110, 150. The power interface 122, 162 may allow for wired and/or wireless transmission of power from the power source to the wireless devices 110, 150 for charging a battery of the wireless devices 110, 150 (e.g., as further shown in FIG. 7 and FIG. 8 and described in further detail below). The power may also be used to power the wireless devices 110, 150 while connected to the power source.

According to various aspects, while the wireless devices 110, 150 are paired and tethered to one another via the wireless link 130, the wireless devices 110, 150 may be configured to operate in a low-power mode (e.g., a sniff mode) to check whether the wireless link 130 is active and healthy. In various embodiments, the wireless link 130 may be broken or lost (i.e., the wireless devices 110, 150 become “untethered”) when the wireless devices 110, 150 are no longer within a suitable communication range. For example, Bluetooth generally allows device-to-device connectivity within a short-range up to approximately ten (10) meters, while Wi-Fi Direct and LTE-Direct have relatively longer ranges, with Wi-Fi Direct allowing device-to-device connectivity up to approximately one-hundred (100) meters and LTE-Direct allowing device-to-device connectivity up to approximately five-hundred (500) meters. In any case, the out-of-range scenarios may generally fall into either an “unexpected” category or an “expected” category. In the former case, the untethering may last anywhere from a few seconds to a few minutes (e.g., the user leaves his/her phone on the desk while going to the restroom, signal interference causes the wireless link 130 to be temporarily lost, etc.). In the latter case, however, the untethering may last a substantial period (e.g., from tens of minutes to several hours or indefinitely).

For example, supposing that the wireless device 110 is a wearable smartwatch and the wireless device 150 is a smartphone, the wireless link 130 may be lost when the user goes out to exercise and carries only the wearable smartwatch while leaving the smartphone at home. In another example, the wireless device 110 may be a vehicle infotainment kit, in which case the wireless link 130 may be lost when the user is at work and the car is switched off. Those skilled in the art will appreciate that there may be many example time periods when the wireless link 130 may be lost such that the wireless devices 110, 150 become untethered. In general, when the untethering is expected and/or will last a substantial duration, entering into a higher power mode to reestablish the wireless link 130 may be useless until the user again brings the wireless devices 110, 150 within sufficient proximity to communicate via the wireless link 130. The various aspects and embodiments described herein may avoid or at least reduce the efforts that the wireless devices 110, 150 undertake to reestablish the wireless link 130 in scenarios where the untethering is expected and/or will last a substantial duration. Accordingly, suspending and/or extending a page/scan interval over a duration in which the wireless devices 110, 150 are expected to become untethered can have positive power impact on both wireless devices 110, 150. For example, one of the wireless devices 110, 150 acting as a paging device, a master device, etc. may not need to page the other during the expected untethering period, nor does the wireless device 110, 150 acting as a paged device, a slave device, etc. need to perform scanning procedures to detect connection establishment messages from the other device.

According to various aspects, the expected untethering period(s) can be learned, predicted, or otherwise predetermined in various ways. For example, in various embodiments, the wireless device(s) 110, 150 may employ heuristics to track untethering events in which the wireless link 130 was broken or otherwise lost for more than a certain threshold time (e.g., days, times, and durations associated with the untethering events). Patterns may be identified among the tracked untethering events (e.g., when an untethering event repeats in a periodic way, such as during work hours on weekdays), which may be used to identify one or more expected untethering events. The wireless device(s) 110, 150 may then exchange one or more signals related to the expected untethering event(s) in advance to coordinate a time period during which efforts to reestablish the wireless link 130 may be suspended or reduced. For example, a particular pattern may be established whereby the wireless link 130 is broken every day for around forty-five (45) minutes at or around 6 pm. In such an example, the wireless device(s) 110, 150 may exchange signaling at around 5:50 pm (or another configurable time) to coordinate entering into a non-aggressive mode the next time that the wireless link 130 is lost and to stay in the non-aggressive mode for the next hour or so. The wireless devices 110, 150 may then enter the lower-power/non-aggressive mode and resume normal operations to reestablish the wireless link 130 after the hour has elapsed.

According to various aspects, another way to learn, predict, or otherwise predetermine the expected untethering period(s) may be through calendar events. For example, the wireless device(s) 110, 150 may each have access the same user's calendar, which may have various activities listed for the user. In various embodiments, one or more events in the calendar may be marked using an appropriate tag to indicate that the user does not intend to carry one or more of the wireless device(s) 110, 150 during the marked event(s). The wireless device(s) 110, 150 may thereby explicitly learn about the expected untethering event(s) and exchange appropriate signaling in the same manner as described above to coordinate the time period during which the efforts to reestablish the wireless link 130 may be suspended or at least reduced.

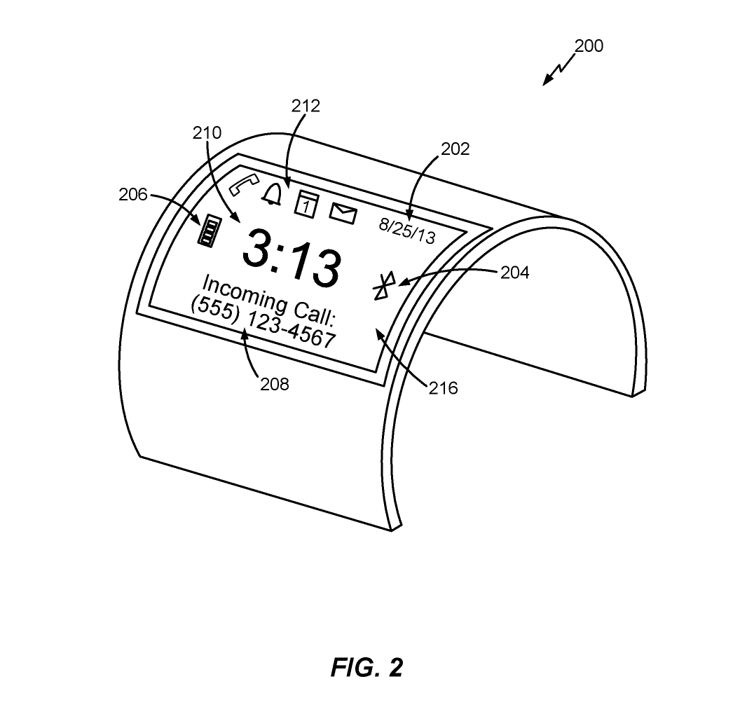

According to various aspects, FIG. 2 illustrates an exemplary wearable device 200 suitable for use in accordance with the various embodiments described herein. In the example shown in FIG. 2, the wearable device 200 is a wrist cuff display, or smart watch. The wearable device 200 may include a display 216, which in this example is a visual display that may have touch screen capabilities. The display 216 may support configurable or non-configurable views that may allow a user to select the items that may be presented on the display 216, and where, when, and how the items may be displayed. Examples of the items the display 216 may present to the user include one or more indicators and/or icons 212 which may represent various information. This information may include information about a tethered device (not explicitly shown), information regarding a current or previous phone call, message information, calendar information, and/or other assorted information. The phone call information may include indications about incoming calls, outgoing calls, and missed calls, as well as the status and number of such calls. The message information may include indications about SMS messages, MMS messages, IMs, emails, and voicemails, such as the status and number of such messages. The calendar information may include indications about appointments, tasks, reminders, and events, such as the status and number of each. The assorted information may include indications about alarms, application updates, and mobile device feature notifications, such as the status and number of each.

In various embodiments, the information shown on the display 216 may include a message from the tethered device indicating that there is an expected untethering impending. As such, the user may interact with the message shown on the display 216 to confirm that a low-power mode during which efforts to reestablish a wireless link with the tethered device will be entered the next time that a wireless link with the tethered device is lost. Alternatively, the user may override the low-power mode and continue normal efforts to reestablish the wireless link once lost despite the potential power impact from the normal efforts. Furthermore, in various embodiments, the calendar information shown on the display 216 may relate to one or more scheduled events or activities during which an expected untethering will occur (e.g., because the user does not intend to carry the wearable device 200, the tethered device, or both).

Other items on the display 216 may include a date 202 in various formats, a connection indicator 204 to show the status and/or strength of a network connection, and a battery indicator 206 that may indicate the battery level and/or battery strength of the wearable device 200 and/or the tethered device. The display 216 may present other types of information, such as text 208 that may indicate information relating to the icons 212, the connection indicator 204, and/or the battery indicator 206. Such text 208 may also indicate the status of a function of the wearable device 200 unrelated to the tethered device. The display 216 may also include one or more date and/or time displays 210 in various formats. The items on the display 216 may be presented to the user and may animate, blink, illuminate, change color, or otherwise modify the items on the display 216 to convey a change in the information that the items represent. The wearable device 200 may also, in conjunction or separately from modifying the items on the display 216, present the user with a sound or tactile sensation to alert the user to or otherwise inform the user about information relating the items shown on the display 216.

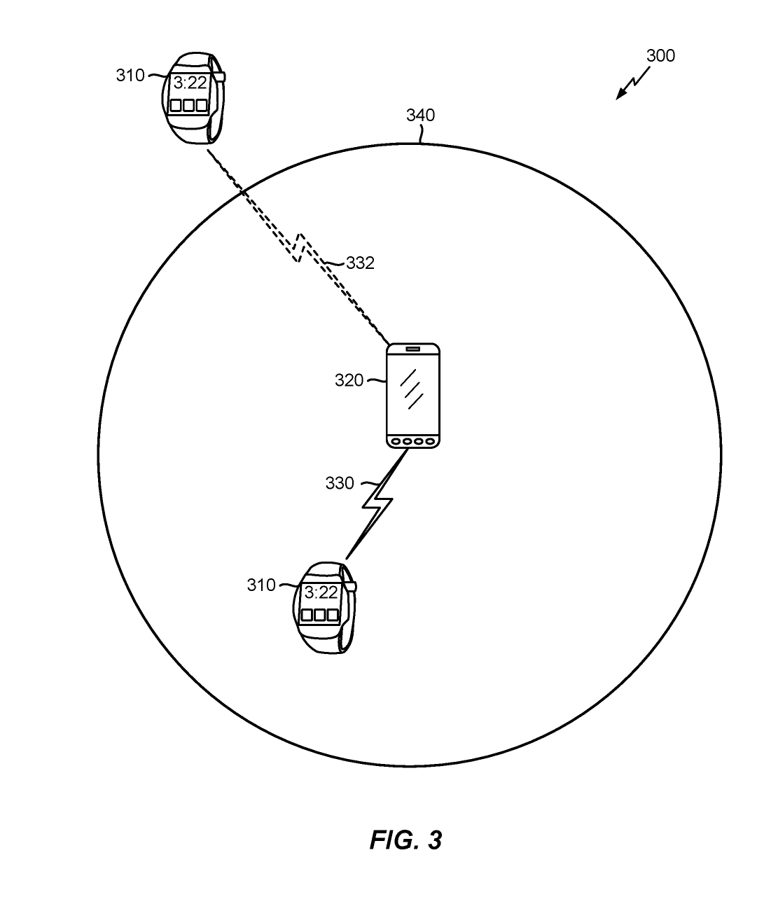

According to various aspects, FIG. 3 illustrates an exemplary system 300 in which a first wireless device 310 and a second wireless device 320 can communicate over a wireless link, including one or more in-range scenarios and one or more out-of-range scenarios. In particular, referring to FIG. 3, area 340 illustrates an overlapping communication reception range of the wireless devices 310, 320. As such, when both wireless devices 310, 320 are located within the area 340, a wireless link between the wireless devices 310, 320 may be successfully established and maintained.

For example, FIG. 4 illustrates an exemplary call flow 400 to show the manner in which the first wireless device 310 and the second wireless device 320 establish, reestablish, or otherwise maintain a wireless link. In the example shown in FIG. 4, the second wireless device 320 is a discovering (or “master”) device and the first wireless device 310 is a discovered (or “slave”) device. However, those skilled in the art will appreciate that the roles of the first and second wireless devices 310, 320 may be suitably reversed. Furthermore, the roles of the first wireless device 310 and/or the second wireless device 320 may be reversed with respect to a third wireless device (not explicitly shown). For example, in the call flow 400 shown in FIG. 4, the second wireless device 320 is a smartphone and the first wireless device 310 is a smartwatch, wherein the smartphone is a master device with respect to the smartwatch but may be a slave device with respect to a vehicle infotainment kit (not explicitly shown).

In various embodiments, with reference to the particular call flow 400 as shown in FIG. 4, the second wireless device 320 will be referred to herein as the “discovering device” 320 and the first wireless device 310 will be referred to herein as the “discovered device” 310. However, those skilled in the art will appreciate that other suitable terminology may be used and that the terms “discovering” and “discovered” are not intended to be limiting in any way.

In various embodiments, to initially establish a direct wireless connection (e.g., when the discovering device 320 and the discovered device 310 have not previously been paired or tethered), the discovering device 320 may operate in an inquiry state 430 to discover or otherwise identify other neighboring devices that are in sufficient range. For example, as depicted at 434, the discovering device 320 may transmit inquiry messages at different frequencies according to a frequency hop sequence. To become discoverable, the discovered device 310 may enter an inquiry scan state 432 while the discovering device 320 is in the inquiry state 430. In response to hearing the inquiry message(s) 434 from the discovering device 320, the discovered device 310 may enter an inquiry response state 436 and transmit an inquiry response message 438 to the discovering device 320. The inquiry response message 438 may include information such as a device access code, address or other suitable identifier associated with the discovered device 310, native clock information, and/or other suitable information associated with the discovered device 310, which may then use the information in the inquiry response message 438 to establish a connection with the discovered device 310. Furthermore, the information in the inquiry response message 438 may be used to subsequently reestablish the connection following an untethering event.

In various embodiments, in response to receiving the inquiry response message 438 from the discovered device 310, the discovering device 320 may enter a page state 440 to activate a connection to the discovered device 310. In particular, the discovering device 320 may send page messages 444 that include the identifier associated with the discovered device 310 in different hop channels. Meanwhile, the discovered device 310 may enter a page scan state 442 during which the discovered device 310 listens for the page messages 444 at a single scan frequency selected according to a page hopping sequence derived from a device address associated with the discovered device 310. Although the discovering device 320 may attempt to have the page messages 444 coincide with the scanning activity at the discovered device 310, the discovering device 320 may not know exactly when and on which frequency the discovered device 310 will scan for the page messages 444 because native clocks at the discovering device 320 and the discovered device 310 are not synchronized. The discovering device 320 may therefore transmit the page messages 444 at different hop frequencies and listen in between transmit intervals until the discovered device 310 hears the page message(s) 444 from the discovering device 320 and enters a page response state 446 to transmit a page response message 448 to the discovering device 320. The discovering device 320 may likewise enter a page response state 450 in response to the page response message 448 from the discovered device 310. The discovering device 320 and the discovered device 310 may then exchange one or more messages 452, 454 to exchange information to synchronize clocks, channel hopping sequences, and/or other information needed to enter a connected state 456 and communicate over an active connection.

Although the call flow 400 shown in FIG. 4 has been described above as including certain states and/or messages communicated between the first wireless device 310 and the second wireless device 320, those skilled in the art will appreciate that other suitable states, messages, etc. may be implemented. For example, when the first wireless device 310 and the second wireless device 320 are configured to connect directly using Wi-Fi Direct or another device-to-device technology, the call flow 400 may include a device discovery state, a service discovery state, and/or other suitable states that are used to establish/reestablish a direct connection. In any case, the call flow 400 may include various operations that are performed at each wireless device 310, 320 and messages to be transmitted between the wireless devices 310, 320, including one or more operations and/or messages used to reestablish a lost or broken connection.

According to various aspects, referring back to FIG. 3, the wireless devices 310, 320 may have the ability to successfully establish and maintain a wireless link when the wireless devices 310, 320 are both located within the area 340 (e.g., via implementing the call flow 400 shown in FIG. 4). During such times, the wireless devices 310, 320 may be paired and tethered to one another via the wireless link, as depicted at 330. While the wireless link 330 is active, the wireless devices 310, 320 may operate in a low-power mode (e.g., a sniff mode, a hold mode, etc.) to occasionally check to make sure that the wireless link 330 is still active and healthy. However, at various times, the wireless devices 310, 320 may move outside the communication reception range of one another, causing the wireless link 330 to be broken or lost, as depicted at 332. Alternatively and/or additionally, the wireless link 330 may be broken or lost when there is radio frequency interference or other signal-degrading circumstances.

In general, when the wireless link 330 is broken or lost, the typical procedure may be to have the wireless devices 310, 320 enter a higher power mode in an effort to reestablish the wireless link 330. For example, in the call flow 400 shown in FIG. 4, the higher power mode may correspond to the portions that start with the page state 440 and the page scan state 442. However, until the wireless devices 310, 320 are again located within the overlapping communication area 340, the discovered device 310 will not receive any page messages 444 that the discovering device 320 transmits no matter how long the discovering device 320 remains in the page state 440 and the discovered device 310 remains in the page scan state 442. As such, the various aspects and embodiments described herein aim to predetermine certain periods when the wireless devices 310, 320 are expected to become untethered such that the power-intensive operations otherwise used to reestablish a lost or broken connection can be suspended or reduced until such a time when the wireless devices 310, 320 may again be within communication range.

More particularly, according to various aspects, FIG. 5 illustrates an exemplary call flow 500 to suspend or reduce attempts to reestablish a wireless link during an expected untethering. For example, an untethering event may generally occur when the wireless devices 310, 320 are paired and tethered over an active wireless connection that is subsequently broken or lost. According to various aspects, the untethering event may be categorized as “unexpected” when the untethering lasts a relatively short time period (e.g., from a few seconds to a few minutes, such as when temporary signal disturbances exist, the user leaves the smartphone 320 on his/her desk while wearing the smartwatch 310 when going to the restroom, etc.). Alternatively, the untethering event may be categorized as “expected” when the untethering can be predicted or otherwise known about in advance and will likely last longer than a given duration. For example, the impact from an interleaved page scan for two (2) hours in an untethered mode can amount to one to several minutes, during which time the page scanning will consume substantial power without performing any useful work because the other device is outside communication range. Likewise, any page messages that the other device transmits may unnecessarily consume power because the page messages will not be receivable at the paged device until the devices are again within communication range. As such, in the following description, efforts to reestablish a connection may be suspended or reduced during expected untethering events to avoid unnecessary power consumption while allowing normal reestablishment procedures to be carried out during unexpected untethering events to allow the wireless devices 310, 320 to reestablish the wireless link as soon as possible when the untethering may be short-lived.

Accordingly, in various embodiments, the wireless device 320 may determine that an expected untethering event is impending at block 530. For example, as will be described in further detail below with reference to FIG. 6, the expected untethering event may be predicted or otherwise known about in advance based on a manual user input, information in a calendar indicating that the user does not intend to carry one or both wireless devices 310, 320 at certain times, machine learning algorithms that identify patterns among tracked untethering events, and/or other suitable techniques. In various embodiments, based on the impending expected untethering event, the wireless device 320 may transmit an expected untethering message 532 to the wireless device 310. For example, the expected untethering message 532 may indicate a time when the untethering event is expected to start, a duration that the untethering event is expected to last, and/or other suitable information (e.g., reestablishment procedures to be used after the time when the untethering event is expected to end). The untethering message 532 may therefore notify the wireless device 310 that normal reestablishment procedures can be suspended or reduced for a given period. For example, the wireless device 310 may suspend page scans during the expected untethering, increase an interval between page scans during the expected untethering, etc. In various embodiments, as depicted at block 534, the wireless device 310 may optionally display a message to confirm or override the instruction to suspend or reduce reestablishment procedures during the impending untethering event. In response to an automatic and/or user confirmation, the wireless device 310 may optionally transmit an acknowledgement 536 to the wireless device 320 to confirm that reestablishment procedures will be suspended or reduced during the impending untethering event. In various embodiments, as depicted at blocks 538, 540, the wireless devices 310, 320 may each suspend or reduce reestablishment procedures.

Accordingly, the next time that the wireless link between the wireless devices 310, 320 is lost or broken, an expected untethered period 542 may begin. During the expected untethered period 542, the wireless device 320 may suspend transmitting page messages to the wireless device 310 or at least increase a paging interval. Likewise, the wireless device 310 may not scan for page messages from the wireless device 320 or at least increase an interval between page scans. In this manner, the suspended/reduced reestablishment procedures may have a positive power impact at both wireless devices 310, 320. In various embodiments, as depicted at blocks 548, 550, the wireless devices 310, 320 may resume normal reestablishment procedures in an effort to reestablish the wireless link therebetween as soon as possible once the expected untethered period 542 has ended. Alternatively, in various embodiments, either or both wireless devices 310, 320 may resume normal reestablishment procedures sooner in response to a manual trigger as depicted at 544, 546 (e.g., the user may have taken a shorter evening jog than usual, cancelled an activity corresponding to a scheduled untethered event as designated in a user calendar, etc. and wishes to reestablish the wireless link immediately). Furthermore, as noted above, the wireless device 310 may give the user the option to override the low-power mode in which reestablishment procedures are suspended or reduced. As such, as depicted at 535, the wireless device 310 may continue with normal reestablishment procedures in response to a user override.

According to various aspects, FIG. 6 illustrates an exemplary method 600 to suspend or reduce attempts to reestablish a wireless link during an expected untethering. In various embodiments, as depicted at block 620, either or both wireless devices that are connected over the wireless link may determine that an expected untethering event is impending. In various embodiments, as depicted at block 616, the expected untethering event may be explicitly determined based on an indication received from a user.

Furthermore, in various embodiments, either or both wireless devices may employ heuristic methods to predict impending untethering events. For example, in various embodiments, either or both wireless devices may be configured to track untethering events at block 610. The untethering events that are tracked may be limited to events in which the wireless link was lost or broken for more than a threshold time period to exclude certain untethering events that may be transient or short-lived. In various embodiments, the untethering events may be tracked with respect to days, times, durations, locations, and/or other suitable information. Accordingly, at block 612, one or more patterns may be identified among the tracked untethering events to predict or otherwise predetermine the impending expected untethering event. For example, a pattern may be established whereby the wireless link is typically lost around 6 pm every day and reestablished about 45 minutes later.

In various embodiments, another way that the expected untethering event may be determined is based on scheduled untethered events. For example, as depicted at block 614, either or both wireless devices may have access to a user's calendar. As such, one or more scheduled events in the calendar may be tagged with appropriate information to indicate that the user will not be carrying either or both devices.

In any case, upon determining that the expected untethering event is impending, the wireless devices may exchange appropriate untethering signaling at block 622 to coordinate the time period during which reestablishment procedures can be suspended or reduced. For example, in the above scenario where the wireless link is typically lost around 6 pm every day and reestablished about 45 minutes later, the signaling may be exchanged at block 622 ten (10) minutes prior to the expected untethering or at another suitable time in advance of the untethering. As depicted at block 624, the wireless device(s) may then suspend or reduce the reestablishment procedures when the impending untethering event occurs (i.e., the next time that the wireless link is lost or broken), which may comprise operating the wireless device(s) in an appropriate low-power mode until the untethering event is expected to end. As such, in various embodiments, the wireless device(s) may resume normal reestablishment procedures at block 626 upon determining that the expected untethering period has ended.

According to various aspects, FIG. 7 illustrates an exemplary mobile device 700 suitable for use in accordance with the various embodiments described herein. For example, in various embodiments, the mobile device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. The mobile device 700 may have one or more radio signal transceivers 708 (e.g., Peanut®, Bluetooth®, Zigbee®, Wi-Fi, RF radio) and antennae 710, configured to send and receive, coupled to each other and/or to the processor 702. The transceivers 708 and antennae 710 may be used with the above-mentioned circuitry to implement the various wireless transmission protocol stacks and interfaces. The mobile device 700 may include a cellular network wireless modem chip 716 that enables communication via a cellular network and is coupled to the processor 702. The mobile device 700 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not explicitly shown in FIG. 7). The mobile device 700 may also include one or more speakers 714 to provide audio outputs. The mobile device 700 may also include a housing 720, which may be constructed of a plastic, metal, or a combination of materials, to contain all or some of the components discussed herein. The mobile device 700 may include a power source 722 coupled to the processor 702, such as a disposable or rechargeable battery. The rechargeable battery 722 may also be coupled to the peripheral device connection port to receive a charging current from a source external to the mobile device 700.

According to various aspects, FIG. 8 illustrates an exemplary wearable device 800 suitable for use in accordance with the various embodiments described herein. For example, in various embodiments, the wearable device 800 may include a processor 802 coupled to a volatile and/or non-volatile internal memory 804, which may be secure and/or encrypted memories, unsecure and/or unencrypted memories, or any combination thereof. In various embodiments, the processor 802 may also be coupled to an electronic display screen 806, which may be a touch screen display (e.g., resistive-sensing touch screen, capacitive-sensing touch screen, infrared sensing touch screen, etc.). A touch screen controller 828 may be coupled to the processor 802 and the electronic display screen 806. The wearable device 800 may include wide area network (WAN) communications circuitry, such as one or more transceivers 814, such as a cellular telephone transceiver or LTE radio module, coupled to an antenna 808 configured to send and receive electromagnetic radiation. The WAN transceiver 814 and antenna 808 may be used to communicate information over a cellular communications network. The wearable device 800 may also include low-power short-range communication circuitry 824, such as a Bluetooth transceiver 824, coupled to an antenna 826 and to the processor 802. The low-power short range communication circuitry 824 may be configured to communicate with a compatible transceiver in the mobile device using one or more of Bluetooth®, Wi-Fi, Peanut®, ZigBee®, ANT, or another suitable low-power wireless communication protocol currently available or which may be developed in the future.

In various embodiments, the wearable device 800 may further include a slide sensor 810 and physical buttons 812 configured to receive user inputs. The wearable device 800 may also include a battery 816 coupled to an inductive charging circuit 818, and a coil antenna 820, which may be an inductive coil adapted to enable inductive charging of the battery 816. The battery 816 and inductive charging circuit 818 may be coupled to the processor 802 to enable the wearable device 800 to control inductive charging and generate messages via the coil antenna 820. The wearable device 800 may further include a vibratory motor 822, and various sensors (e.g., gyroscopes, accelerometers, pedometers, thermometers, thermocouples, etc.) 830, all of which may be coupled to the processor 802.

In various embodiments, the wearable device 800 may include a global positioning system receiver 830 coupled to the processor 802 and which supports United States Global Positioning System (GPS) or other global navigation or satellite positioning systems, such as the Russian GLONASS system and the European Galileo System. The wearable device 800 may also include a biological or physiological sensor 832 configured to monitor one or more physiological parameters, such as heart rate, variability in heart rate, breathing rate, arrhythmia of the heart (if any), general rhythm and functioning of the heart, blood pressure, body movements (i.e., physical activity), steps taken (e.g., a pedometer), body position, body temperature, presence and quantity of sweat, oxygenation, etc. Such sensor(s) 832 may be coupled to the processor 802.

In various embodiments, the electrical components of the wearable device 800 may be integrated and coupled together using surface mount technologies in which components are mounted or placed directly onto the surface of a printed circuit board 826, on a conventional circuit board 826 with through-board connections, multi-chip modules, system on chips (SoC), or any other electrical component mounting, manufacturing, or electronics technology that is currently known or which may be developed in the future. The electrical components of the wearable device 800 may be integrated within a package encompassed by a bezel 840 surrounding the electronic display screen 806 that is coupled to a wrist band 842 so that a user can wear the wearable device 800 like an ordinary watch.

Those skilled in the art will appreciate that information and signals may be represented using any of various different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for power savings in a wireless device, comprising:
establishing, at a first wireless device, a wireless link with a second device, wherein the first wireless device is tethered to the second device over the wireless link;
determining, at the first wireless device, that a scheduled untethering of the wireless link with the second device is impending; and
reducing a duty cycle associated with one or more procedures to reestablish the wireless link in response to determining that the wireless link with the second device has been lost, wherein the duty cycle is reduced for a period that substantially corresponds to an expected duration of the scheduled untethering of the wireless link.

2. The method recited in claim 1, wherein the scheduled untethering is an event for which a user has indicated that the first wireless device and the second device will not be within communication reception range.

3. The method recited in claim 1, wherein the scheduled untethering is an event stored in a calendar associated with the user and tagged with information to indicate that the first wireless device and the second device will not be within communication reception range.

4. The method recited in claim 1, further comprising:
tracking information associated with one or more scheduled untethering events over time, wherein the tracked information includes at least days, times, and durations in which the first wireless device becomes untethered from the second device; and
identifying one or more patterns among the tracked information associated with the one or more scheduled untethering events, wherein the scheduled untethering is determined based at least in part on the one or more identified patterns.

5. The method recited in claim 1, further comprising receiving, at the first wireless device, an input from a user indicating that the scheduled untethering is impending.

6. The method recited in claim 1, further comprising receiving, at the first wireless device, a message from the second device via the wireless link, wherein the message from the second device indicates that the scheduled untethering is impending and further indicates a start time and the expected duration of the scheduled untethering.

7. The method recited in claim 1, wherein reducing the duty cycle associated with the one or more procedures to reestablish the wireless link comprises suspending one or more of page messages to be transmitted to the second device or operations to scan for page messages transmitted from the second device.

8. The method recited in claim 1, wherein reducing the duty cycle associated with the one or more procedures to reestablish the wireless link comprises increasing one or more of a paging interval or a page scanning interval.

9. The method recited in claim 1, further comprising resuming a normal duty cycle for the one or more procedures to reestablish the wireless link after the expected duration of the scheduled untethering has elapsed.

10. The method recited in claim 1, further comprising transmitting a message to the second device to indicate that the scheduled untethering is impending, wherein the message transmitted to the second device further indicates a start time and the expected duration of the scheduled untethering.

11. An apparatus, comprising:
a memory; and
a processor coupled to the memory and configured to establish a wireless link with a tethered device, determine that a scheduled untethering of the wireless link with the tethered device is impending, and reduce a duty cycle associated with one or more procedures to reestablish the wireless link in response to loss of the wireless link with the tethered device, wherein the duty cycle is reduced for a period that substantially corresponds to an expected duration of the scheduled untethering of the wireless link.

12. The apparatus recited in claim 11, wherein the scheduled untethering is an event for which a user has indicated that the apparatus and the tethered device will not be within communication reception range.

13. The apparatus recited in claim 11, wherein the memory is configured to store information related to the scheduled untethering in a calendar associated with the user, the stored information tagged with information to indicate that the apparatus and the tethered device will not be within communication reception range.

14. The apparatus recited in claim 11, wherein the processor is further configured to:
track information associated with one or more scheduled untethering events over time, wherein the tracked information includes at least days, times, and durations in which the apparatus becomes untethered from the tethered device; and
identify one or more patterns among the tracked information associated with the one or more scheduled untethering events, wherein the scheduled untethering is determined based at least in part on the one or more identified patterns.

15. The apparatus recited in claim 11, further comprising an input device configured to receive an input from a user indicating that the scheduled untethering is impending.

16. The apparatus recited in claim 11, further comprising a wireless receiver configured to receive a message from the tethered device via the wireless link, wherein the message from the tethered device indicates that the scheduled untethering is impending and further indicates a start time and the expected duration of the scheduled untethering.

17. The apparatus recited in claim 11, wherein one or more of page messages to be transmitted to the tethered device or operations to scan for page messages transmitted from the tethered device are suspended while the duty cycle is reduced.

18. The apparatus recited in claim 11, wherein one or more of a paging interval or a page scanning interval is increased while the duty cycle is reduced.

19. The apparatus recited in claim 11, wherein the processor is further configured to resume a normal duty cycle for the one or more procedures to reestablish the wireless link after the expected duration of the scheduled untethering has elapsed.

20. The apparatus recited in claim 11, further comprising a wireless transmitter configured to transmit a message to the tethered device to indicate that the scheduled untethering is impending, wherein the message transmitted to the tethered device further indicates a start time and the expected duration of the scheduled untethering.

21. An apparatus, comprising:
means for establishing a wireless link with a tethered device;
means for determining that a scheduled untethering of the wireless link with the tethered device is impending; and
means for reducing a duty cycle associated with one or more procedures to reestablish the wireless link in response to loss of the wireless link with the tethered device, wherein the duty cycle is reduced for a period that substantially corresponds to an expected duration of the scheduled untethering of the wireless link.

22. The apparatus recited in claim 21, wherein the scheduled untethering is an event for which a user has indicated that the apparatus and the tethered device will not be within communication reception range.

23. The apparatus recited in claim 21, further comprising means for storing information related to the scheduled untethering in a calendar associated with the user, the stored information tagged with information to indicate that the apparatus and the tethered device will not be within communication reception range.

24. The apparatus recited in claim 21, further comprising:
means for tracking information associated with one or more scheduled untethering events over time, wherein the tracked information includes at least days, times, and durations in which the apparatus becomes untethered from the tethered device; and
means for identifying one or more patterns among the tracked information associated with the one or more scheduled untethering events, wherein the scheduled untethering is determined based at least in part on the one or more identified patterns.

25. The apparatus recited in claim 21, further comprising means for receiving an input from a user indicating that the scheduled untethering is impending.

26. The apparatus recited in claim 21, further comprising means for receiving a message from the tethered device via the wireless link, wherein the message from the tethered device indicates that the scheduled untethering is impending and further indicates a start time and the expected duration of the scheduled untethering.

27. The apparatus recited in claim 21, wherein one or more of page messages to be transmitted to the tethered device or operations to scan for page messages transmitted from the tethered device are suspended while the duty cycle is reduced.

28. The apparatus recited in claim 21, wherein one or more of a paging interval or a page scanning interval is increased while the duty cycle is reduced.

29. The apparatus recited in claim 21, further comprising means for transmitting a message to the tethered device to indicate that the scheduled untethering is impending, wherein the message transmitted to the tethered device further indicates a start time and the expected duration of the scheduled untethering.

30. A computer-readable storage medium storing computer-executable instructions, the computer-executable instructions configured to cause a processor to:
establish a wireless link with a tethered device;
determine that a scheduled untethering of the wireless link with the tethered device is impending; and
reduce a duty cycle associated with one or more procedures to reestablish the wireless link in response to loss of the wireless link with the tethered device, wherein the duty cycle is reduced for a period that substantially corresponds to an expected duration of the scheduled untethering of the wireless link.
